(19) United States
(12) Patent Application Publication
(10) Pub. No.: US 2006/0132414 A1
(43) Pub. Date: Jun. 22, 2006

(54) Liquid crystal display with nightlight

(75) Inventor: Yu-Shan Yiu, Jhonghe City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: HANNSPREE, INC., Taipei (TW)

(21) Appl. No.: 11/087,508

(22) Filed: Mar. 24, 2005

(30) Foreign Application Priority Data
Dec. 21, 2004 (TW) 093220594

(51) Int. Cl. G09G 3/36

(52) U.S. Cl. 345/98

(57) ABSTRACT

The present invention is about a liquid crystal display (LCD) with nightlight including a display housing and a liquid crystal panel that is received in the inner chamber of the display housing. A display panel of the liquid crystal panel corresponds to a front opening of the display housing, and at least one nightlight of the liquid crystal panel is electrically connected to the power supply and corresponds to at least one window. The controller, which is connected electrically to the power supply, controls the at least one nightlight. Therefore the LCD possesses both information display and nightlight function during the course of operation.

### BACKGROUND OF THE INVENTION

1. Field of the Invention

The present invention relates to the field of a liquid crystal display (LCD), and more particularly, to an LCD with an additional nightlight being built there into.

2. Description of Related Art

A display device in general comprises a display screen on which the users are able to obtain the content of information that they are looking for. As an example of a computer device, its display screen, as a medium, provides the user a visual display of any input or output results after computations. Another example would be the present popular LCD television which can display programs from numerous channels for viewers' pleasure while taking up far less space than the cathode ray tube TV.

Yet a display device, in general, which solely provides information display, as its only function is considered relatively common without being able to offer any other special features. Nowadays as the overall consumer preference is towards increasingly higher standards, consumers will seek even more features and functions in terms of recreational purpose other than just the display itself while operating the device; therefore, the conventional display device mentioned above is no longer able to serve consumers' ever-increasing demands. By adding supplementary features or functions to satisfy such demands has become one of the main challenges in which the industry should put effort into under the present trend.

### SUMMARY OF THE INVENTION

The present invention has been accomplished under the circumstances in view. It is therefore the main object of the present invention to provide an LCD with nightlight.

To achieve this and other objects of the present invention, the LCD with nightlight comprises a display housing and a liquid crystal panel. The inside the display housing receives an inner chamber, where there is a front opening, and the display housing has a least one window.

Further, the liquid crystal display module is mounted in the inner chamber of the display housing, and it comprises a display screen, at least one nightlight, a power supply, and a controller. The display screen is mounted correspondingly to the front opening of the display housing. The at least one nightlight is electrically connected to the power supply and mounted corresponding to the at least one window of the display housing, and the controller is electrically connected to the power supply and adapted to control the at least one nightlight.

Following the structure mentioned above, the at least one nightlight can be turned on during the course of operating the LCD, thus making the LCD possess both the information display and nightlight function at once. Such nightlight function can be utilized, for instance, during nighttime or whenever the light surrounding the LCD is comparatively dim.

The at least one window of the display housing can be interconnected with the inner chamber and to the exterior of the display housing; the structure can also comprise at least one light cover, which can cover the at least one window. The at least one light cover thereof can be a transparent cover, a semi-transparent cover, or a tinted transparent cover.

In addition, the display housing can comprise a photo sensor that is mounted on the display housing. The photo sensor can detect the brightness of the environment surrounding the display housing and send out a corresponding controlling signal. The controlling signal can be sent to the controller for controlling the at least one nightlight thereof. Similarly the display housing can further comprise a switch button, which is mounted on the display housing. The switch button is electrically connected to the controller and can send out a corresponding controlling signal in which the controlling signal then can be sent to the controller for controlling the at least one nightlight.

Further, the at least one nightlight thereof can comprise a light emitting diode (LED), a high-luminosity LED, a light bulb, or multi-color LEDs'.

Also, the display housing can comprise a front case and a rear case mounted on the front case. The front opening can be formed in the front case, and the at least one window can be formed in the rear case.

### BRIEF DESCRIPTION OF THE DRAWINGS

FIG. 1 is a perspective view of an LCD with nightlight demonstrated in separate parts according to the present invention.

FIG. 2 is a sectional perspective view of the present invention taken in an enlarged scale.

FIG. 3 is a structural map of the function theory underlain within the present invention.

### DETAILED DESCRIPTION OF THE PREFERRED EMBODIMENT

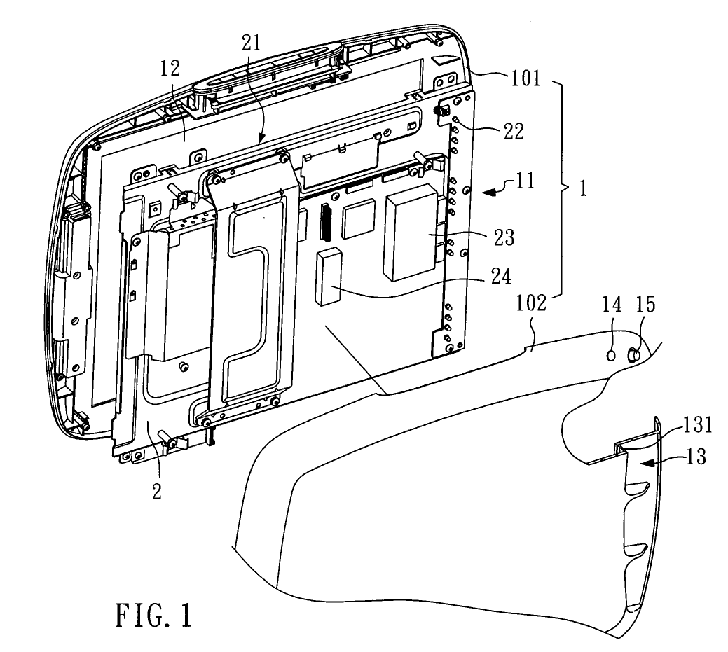

FIG. 1 is a perspective view of the present invention in separate parts that shows a display housing 1 within which a liquid crystal panel 2 is received.

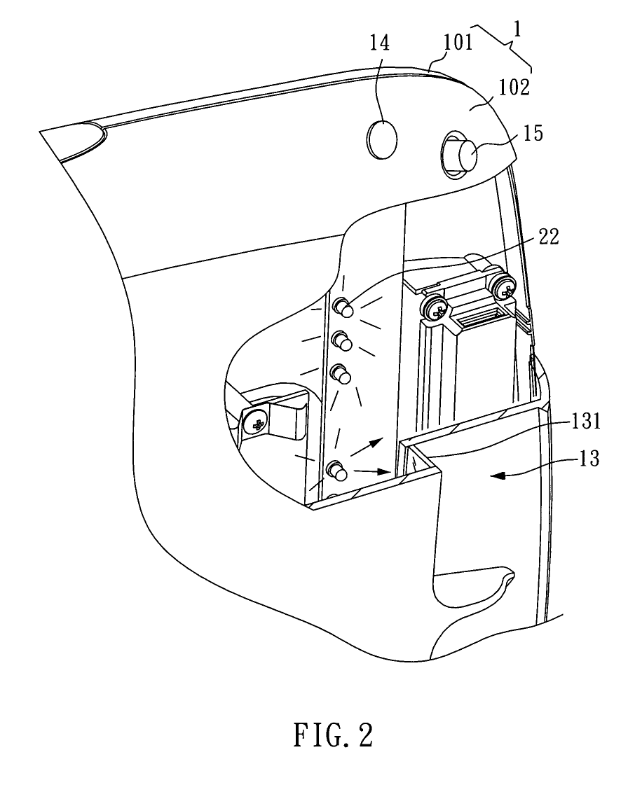

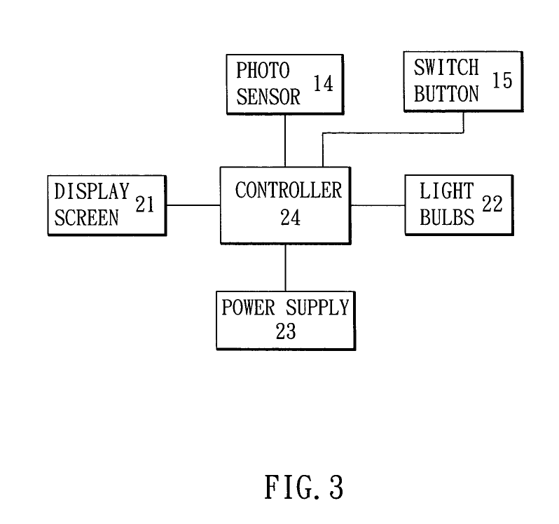

Referring to FIG. 1, FIG. 2, and FIG. 3, FIG. 2 is a sectional perspective view of the present invention taken in an enlarged scale, and FIG. 3 is a structural map of the function theory underlain within the present invention. The display housing 1 comprises a front case 101 and a rear case 102 mounted on the front case 101; an inner chamber 11 is formed inside of the display housing 1. The front portion of the display housing 1, namely the front case 101, has a front opening 12 whereas the back of the display housing 1, namely the rear case 102, has multiple windows 13. These multiple windows 13 interconnect with the inner chamber 11 of the display housing 1 and to the exterior of the display housing 1 respectively. A light cover 131 covers up the outer of the multiple windows 13 of the display housing 1. In this embodiment the light cover 131 is a semi-transparent cover; however, the scope of the present invention shall not be confined within such limit whereas the utilizations of any other transparent or colored materials through which light shall transmit are all applicable.

Further, the liquid crystal panel 2, mounted in the inner chamber 11 of the display housing 1, comprises a display panel 21, multiple nightlights 22, a power supply 23, and a controller 24. As the liquid crystal panel 2 is received inside of the display housing 1, the display panel 21 of the liquid crystal panel 2 is then located at the corresponding front opening 12 of the display housing 1. Multiple nightlights 22 in this embodiment each utilize a light emitting diode (LED) for the latter's high-luminosity characteristic. The quantity of the nightlights 22 is identical to the number of the windows 13 of the display housing 1 that there are in this embodiment, but such number is subject to change according to the design in practice. Also, multiple nightlights 22, corresponding to multiple windows 13 are respectively electrically connected to the power supply 23, as is the controller 24.

Additionally in this embodiment, the display housing 1 further comprises a photo sensor 14 and a switch button 15, which both are mounted separately on the rear case 102 of the display housing 1.

When a user is operating the LCD, the photo sensor 14 can simultaneously detect the current brightness of the environment surrounding the display housing 1; if the degree of surrounding light is relatively dim, the photo sensor 14 then can send out a corresponding controlling signal to the controller 24 such that the multiple nightlights 22 can be automatically controlled by the controller 24.

Similarly, the user can too use the switch button 15 manually for controlling the multiple nightlights 22. This switch button 15 is electrically connected to the controller 24; thus whenever the user would like to turn on the multiple nightlights 22, the switch button 15 can simply be pressed such that a corresponding controlling signal will be sent out to the controller 24 by which the multiple nightlights 24 are controlled. Thus, the user can manually or even overridingly press the switch button 15 to turn on the multiple nightlights 22.

Therefore, when the user is operating the LCD, the liquid crystal panel 2 can simultaneously produce light glow. Adding such nightlight function onto the already-existing information display function brings out and enhances recreational and originality values of the LCD to the users.

If the user desires color variation in the light glow while operating the LCD, the light cover 131 can be changed to a transparent cover or a colored transparent cover such that color variation can be achieved via the light glow transmitting through the transparent or the colored transparent light cover. The user can too substitute the multiple nightlights 22 with conventional light bulbs or multi-colored light emitting diodes as alternatives such that the liquid crystal panel 2 is able to present various types of visual effect. Furthermore, although the multiple nightlights 22, the light cover 131, and the window 13 are located at the side of corresponding display body in this embodiment, their locations could also be modified to the top or the bottom of the display body subject to the design in practice.

Although the present invention has been explained in relation to its preferred embodiment, it is to be understood that many other possible modifications and variations can be made without departing from the spirit and scope of the invention as hereinafter claimed.

What is claimed is:

1. A liquid crystal display with nightlight comprising:
a display housing, said display housing comprising an inner chamber, a front opening, and at least one window; and
a liquid crystal panel received in the inner chamber of said display housing, said liquid crystal panel comprising a display screen mounted correspondingly to the front opening of said display housing, a power supply, at least one nightlight electrically connected to said power supply and mounted corresponding to said at least one window, and a controller electrically connected to said power supply and adapted to control said at least one nightlight.

2. The liquid crystal display with nightlight as in claim 1, further comprising at least one light cover covering said at least one window.

3. The liquid crystal display with nightlight as in claim 2, wherein said at least one light cover is a transparent cover.

4. The liquid crystal display with nightlight as in claim 1, wherein said display housing further comprising a photo sensor mounted on said display housing and adapted to detect a light level surrounding the liquid crystal display and to send out a corresponding controlling signal to said controller.

5. The liquid crystal display with nightlight as in claim 1, wherein said display housing further comprising a switch button mounted on said display housing and electrically connected to said controller for sending out a controlling signal to said controller.

6. The liquid crystal display with nightlight as in claim 1, wherein said at least one nightlight comprising a light emitting diode.

7. The liquid crystal display with nightlight as in claim 1, wherein said at least one nightlight comprising a multi-colored light emitting diode.

8. The liquid crystal display with nightlight as in claim 1, wherein said display housing comprising a front case and a rear case mounted on said front case, said front opening is formed in said front case, and said at least one window is formed in said rear case.
